(19) United States
(12) Patent Application Publication
(10) Pub. No.: US 2008/0167891 A1
(43) Pub. Date: Jul. 10, 2008

(54) Systems, Devices and Methods for Consumer Segmentation

(75) Inventors: Wendy F. Cohn, Charlottesville, VA (US); Arthur Garson, Charlottesville, VA (US); Mable B. Kinzie, Charlottesville, VA (US); Jason A. Lyman, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(73) Assignee: UNIVERSITY OF VIRGINIA PATENT FOUNDATION, Charlottesville, VA (US)

(21) Appl. No.: 11/958,000

(22) Filed: Dec. 17, 2007

Related U.S. Application Data
(60) Provisional application No. 60/875,433, filed on Dec. 18, 2006.
(60) Provisional application No. 60/986,111, filed on Nov. 7, 2007.
(60) Provisional application No. 60/991,037, filed on Nov. 29, 2007.

(51) Int. Cl. G06Q 99/00

(52) U.S. Cl. 705/1

(57) ABSTRACT

The selection and delivery of information to consumers is improved by a method and system for developing consolidated information and consumer classes. Consolidated classes permit direct matching of efficient packages of information to consumers. Consolidated classes also permit the identification and delivery of information to both consumers who actively seek information and consumers who do not actively seek information.

### CROSS REFERENCE TO RELATED APPLICATIONS

This application claims priority from U.S. Provisional patent application Ser. No. 60/875,433, filed on Dec. 18, 2006, entitled “Method, System and Computer Program Product for the Tailored Educational Approaches to Consumer Health (TEACH) Mode;” U.S. Provisional application Ser. No. 60/986,111, filed Nov. 7, 2007 entitled “Method, System and Computer Program Product for the Tailored Educational Approaches to Consumer Health (TEACH) Mode;” and “U.S. Provisional application Ser. No. 60/991,037, filed Nov. 29, 2007 entitled “Method, System and Computer Program Product for the Tailored Educational Approaches to Consumer Health (TEACH) Mode,” the entire disclosures of which are hereby incorporated by reference herein in their entirety.

### FIELD OF THE INVENTION

This invention relates to a method for segmenting a target population, classifying information, and matching members of the segmented population with the information for the purpose of efficiently disseminating quality information to the target population.

### BACKGROUND OF THE INVENTION

Recently, there have been two major changes in the way consumer education is being delivered. First, Internet-based technologies have enabled new approaches to the development, delivery and access of educational resources. Second, the practice of “tailoring” information resources to the individual is being validated and refined. Tailored resources have been developed with certain individual characteristics and preferences taken into account, but have typically focused on a small number of factors within a particular context. Furthermore, they have failed to achieve the efficiency and public good obtainable from a system which can both directly allocate individual educational materials to consumer segments, regardless of information-seeking behavior, and properly balance the efficiency concerns of both information providers and consumers.

For instance, U.S. Pat. No. 6,286,005 issued to Cannon discloses a rating system for proposed advertising schedules based on past viewing habits of consumers. Such a system permits the rating of information, but it does not provide a mechanism for classifying information or consumers.

Both U.S. Pat. No. 6,996,560 issued to Choi et al. ('560) and PCT App. WO 07/117,980 disclose the use of clustering analysis for consumer segmentation. The '560 patent, for instance, uses the responses obtained from a survey to classify consumers. However, no means are provided for classifying information to be provided to those consumers.

PCT App. WO 06/068691 discloses a method for collecting data concerning consumer preferences in order to predict the desirability of future products. However, no means are provided for classifying consumers; rather, once the desirable products are segmented, they are presented to all consumers who must segment themselves according to their own preferences. There is still a need for a method matching groups of consumers to the products which they seek or need.

U.S. Pat. No. 5,956,693 issued to Geerlings discloses a method for delivering information to consumers based on their individual demographics, past shopping activities, and communication preferences. However, this system requires individual tailoring at a cost to overall efficiency. Efficiency can be drastically improved through a system that identifies the important factors shared by a group of individuals and creates packages of information for that group, rather than catering to each individual personally. Similarly, PCT App. WO 02/05123 discloses the use of a user's psychological significance pattern to match the user with target information, but also lacks the efficiency obtained through the packaging of information for discrete segments of users.

U.S. Pat. No. 7,143,066 issued to Shear et al. discloses the classification of information into content classes and users into user classes. Such a method, however, requires a mechanism for matching the user classes to the content classes. This mechanism must be employed in response to each user query for information. Such a method, therefore, lacks the efficiency that can be obtained from assigning information and consumers to a consolidated information and consumer class.

The prior art does not contain a means for the systematic and efficient matching and delivery of existing and future educational information to groups of existing and future consumers. While the prior art discloses consumer segmentation and information segmentation, it does not provide a means for segmenting both consumers and information into identical classes so that information may be assorted into efficient packages for the targeted delivery to segments of consumers possessing similar informational needs. The prior art also lacks a means to identify and deliver information to consumers who are not actively seeking information.

### SUMMARY OF THE INVENTION

An aspect of various embodiments of the present invention solves the prior art deficiencies by providing a method and system for information delivery, which achieves significant efficiency gains through discrete consolidated information-consumer classes and the packaging of information according to such classes for targeted communication to consumers.

An aspect of an embodiment of the present invention provides a method and system for developing classes into which both information and consumers may be classified together.

An aspect of an embodiment of the present invention provides a method and system for assigning both information and consumers to consolidated information-consumer classes.

In general, the selection and delivery of information to consumers is improved by aspects of the present method and related system for developing consolidated information and consumer classes. Consolidated classes permit direct matching of efficient packages of information to consumers. Consolidated classes also permit the identification and delivery of information to both consumers who actively seek information and consumers who do not actively seek information.

An aspect of an embodiment of the present invention provides a method and system for providing information to consumers based simply on the class to which each are assigned, thereby obviating or diminishing the need for a further method or system to match information directly to consumers. This also obviates or diminishes the need for consumers to actively seek the information, since a consumer can be matched to information based simply on his or her personal characteristics. While it's not necessary for the consumers to actively seek the information, in an embodiment the method and system may encourage such activity of the consumer. The ability to identify and provide information to a consumer who does not know he or she needs such information allows for valuable and, in some contexts, life-saving interventions.

An aspect of an embodiment of the present invention provides a method and system for identifying appropriate packages of information, or the lack of an appropriate package of information, for identified consumer segments. By appropriately packaging information, an efficient balance is achieved between the costs to information-providers and the costs to information-consumers. The information-provider does not need to individually tailor the information for each consumer, and the information-consumer does not need to scour onerous amounts of general information for the specific information which the consumer needs.

As stated herein, an aspect of an embodiment of the present invention provides a method and system for providing information to consumers. For example, such consumers may be, but not limited thereto, consumers of healthcare information, students of a university or other academic settings, or purchasers of products, as well as any other applicable industries or fields, whereby it is desired or required to practice the present invention. As it may pertain to the healthcare field, for instance, end-users may include, but are not limited thereto, physicians, patients, clinicians, administrators, insurance companies, pharmaceutical companies, etc.

An aspect of an embodiment of the present invention provides a method for optimizing the selection and delivery of communications. The method comprising the activities of: identifying a plurality of clusters of factor values possessed by a population; producing recommendations for factor values; assigning one or more the recommendations to each of the clusters based on the factor values of the clusters; assessing the ability of one or more communications to satisfy the recommendations; assigning the communications to one or more of the plurality of clusters based on the assessments of the communications to meet the recommendations which were assigned to each cluster; surveying a consumer with a set of questions which elicit personal factor values of the consumer to obtain the consumer's set of personal factor values; assigning the consumer to one of the plurality of clusters based on the consumer's set of personal factor values; and matching the consumer with the communications which are assigned to the same cluster as the consumer.

An aspect of an embodiment of the present invention provides a system for optimizing the selection and delivery of communications. The system comprising: a device (system or means) configured to identify a plurality of clusters of factor values possessed by a population; a decision-maker (device, system, or means) which produces recommendations for factor values; a device (system or means) configured to assign one or more the recommendations to each of the clusters based on the factor values of the clusters; a decision-maker (device, system, or means) which assesses the ability of one or more communications to satisfy the recommendations; a device (system or means) configured to assign the communications to one or more of the plurality of clusters based on the assessments of the communications to meet the recommendations which were assigned to each cluster; a device (system or means) configured to use a set of questions which elicit a set of personal factor values for a consumer to obtain the consumer's set of personal factor values; a device (system or means) configured to assign the consumer to one of the plurality of clusters based on the consumer's set of personal factor values; and a device (system or means) configured to match the consumer with the communications which are assigned to the same cluster as the consumer.

These and other objects, along with advantages and features of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 provides a flow chart that represents the generation of segments and recommendations of various embodiments of the present invention method and system.

FIG. 2 provides a flow chart that represents the classification of communications into the generated segments using the generated recommendations of various embodiments of the present invention method and system.

FIG. 3 represents the classification of consumers into the generated segments of various embodiments of the present invention method and system.

FIG. 4 provides a flow chart that depicts the matching of communications to consumers based on which segment each has been classified into for various embodiments of the present invention method and system.

FIG. 5 provides a schematic block diagram that represents a distributed data processing system suited to practicing the method and related system of the invention.

FIG. 6 exhibits a sample summary of the academic literature concerning the influence of some factors on knowledge and behavior.

FIG. 7 exhibits some sample questions for ascertaining word knowledge.

FIG. 8 exhibits some sample questions for ascertaining delivery preferences.

FIG. 9 exhibits some sample factors with descriptions of how to use questionnaire scores to compute a numerical score describing the value of the factor on a numerical scale.

FIG. 10 exhibits a segregation of factors into basis and predictor/descriptor categories.

FIG. 11 exhibits sample crosswalks representing the differences between cluster solutions.

FIG. 12 exhibits an example of the functions resulting from the multiple discriminant analysis of a cluster solution.

FIG. 13A exhibits sample definitions for five differentiated segments.

FIG. 13B exhibits sample definitions for four additional differentiated segments.

FIG. 14A exhibits numerical scales for determining whether a delivery option should be required for a particular segment.

FIG. 14B exhibits the mean values for various delivery options for each segment.

FIG. 15 exhibits some sample questions for scoring the abilities of communications to meet health status and literacy recommendations.

FIGS. 16A-B exhibit the assignment of point values for answers to the sample questions exhibited in FIG. 15.

### DETAILED DESCRIPTION OF THE INVENTION

In relation to exemplary embodiments, the following definitions can be employed

### Definitions

“Communication” means any perceivable information or any means for disseminating such information. It may encompass both educational information and means for delivering that information, whether requested or not by the consumer of the information.

“Consumer” means any individual who may have any type of need for information, whether the individual knows of the need or not, and whether the individual is actively seeking information or not.

“Factor” means any fact or circumstance that may influence an individual's knowledge or behavior, including an individual's characteristics and preferences.

“Factor value” means a measurement of the presence, absence, status, degree, or level of a factor as it might or might not exist in an individual. The value may be numeric, but does not have to be numeric, as long as it is capable of describing the factor as occurring in one individual relative to the factor as occurring in a second individual.

“Recommendation” means any feature of, or requirement for, a communication which might be beneficial to an individual, including content and delivery options which suit an individual's characteristics and preferences.

“Sample” refers to information obtained from a subset of a population.

### Computer System

While the invention is primarily disclosed as a method, a person having ordinary skill in the art will appreciate that a conventional data processing system, including a central processing unit (CPU), memory, input device, output device, a connecting bus, and other appropriate components, could be programmed or otherwise designed to facilitate the practice of the disclosed method. Additionally, an article of manufacture, such as a pre-recorded storage medium, could include a computer program recorded thereon for directing the data processing system to facilitate the practice of the method of the invention. Such an apparatus or article of manufacture would fall within the spirit of efficiency embodied in the invention.

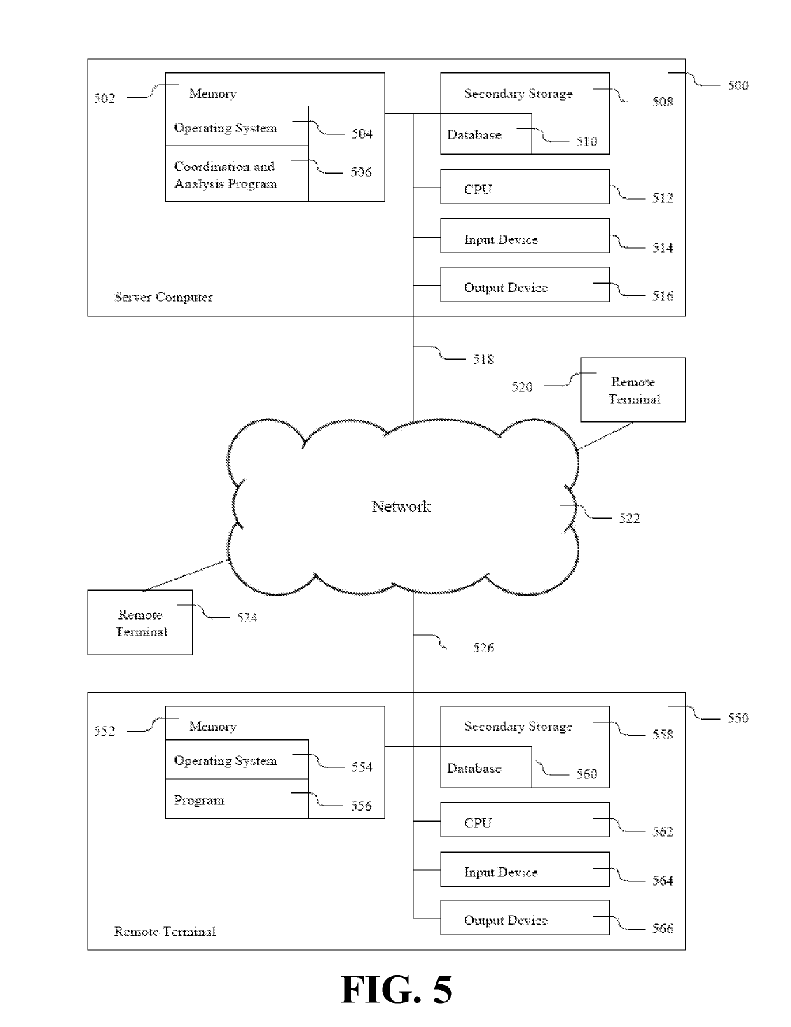

FIG. 5 depicts a data processing system which is suitable for practicing the method of the invention. The depicted data processing system includes one or more remote terminals connected to a server computer via a network; however, it is not necessary for practicing the invention that the system be distributed over a network. A person having ordinary skill in the art will appreciate that the method can also be practiced on a single computer with the components of the server computer. Remote terminals simply facilitate human interaction in the practice of the method, in the event that human interaction is necessary for a particular embodiment of the invention.

Both the server computer 500 and remote terminal 550 include a memory 502/552, a secondary storage device 508/558, a CPU 512/562, an input device 514/564, an output device 516/566, and a network connection 518/526. An operating system 504/554 operates in the memory of both the server computer and remote terminal, performing management functions, which include program management, memory management, CPU operation, input, output, and network operations. A program or set of programs 556 run on the remote terminal which are particularly suited to the terminal and capable of interacting with the server computer via the network connection 526 and input device 564. For example, the program 556 may be an Internet browser capable of accessing and interacting with HTML, XML, or other documents generated by the server computer, or otherwise transferring data obtained from the input device 564 or stored in either the memory 552 or secondary memory 558 to the server computer 500. Other remote terminals are indicated 520/524, which would contain the same essential components as the explicated remote terminal depiction 550.

A program or set of programs 506 run on the server computer 500 which is particularly suited to the server computer. The program or programs are capable of coordinating the remote terminals, interacting with the remote terminals via the network connection 518 and input device 514, storing and reading data to and from its memory 502 and secondary memory 508, manipulating the data via the memory 502 and CPU 512, including formatting and analysis of the data, and storing the results of the manipulation in the memory 502 or secondary memory 508 or displaying the results on the output device 516. The secondary memory 508 of the server computer 500 includes a database 510 which may or may not be accessible by any of the remote terminals having appropriate authorization, depending on the degree of involvement entrusted to the user of a particular remote terminal.

A person having ordinary skill in the art will appreciate that the remote terminals and server computer may contain additional or different components than those depicted in FIG. 5. It will also be appreciated that the network 522 may include a wide area network or a local area network. Furthermore, data stored on and read from the memory of either the remote terminal 550 or server computer 500 may also be stored on and read from other types of computer-readable media. Still further, the databases and programs may be stored on or distributed across other devices on the network.

### Selection of Factors

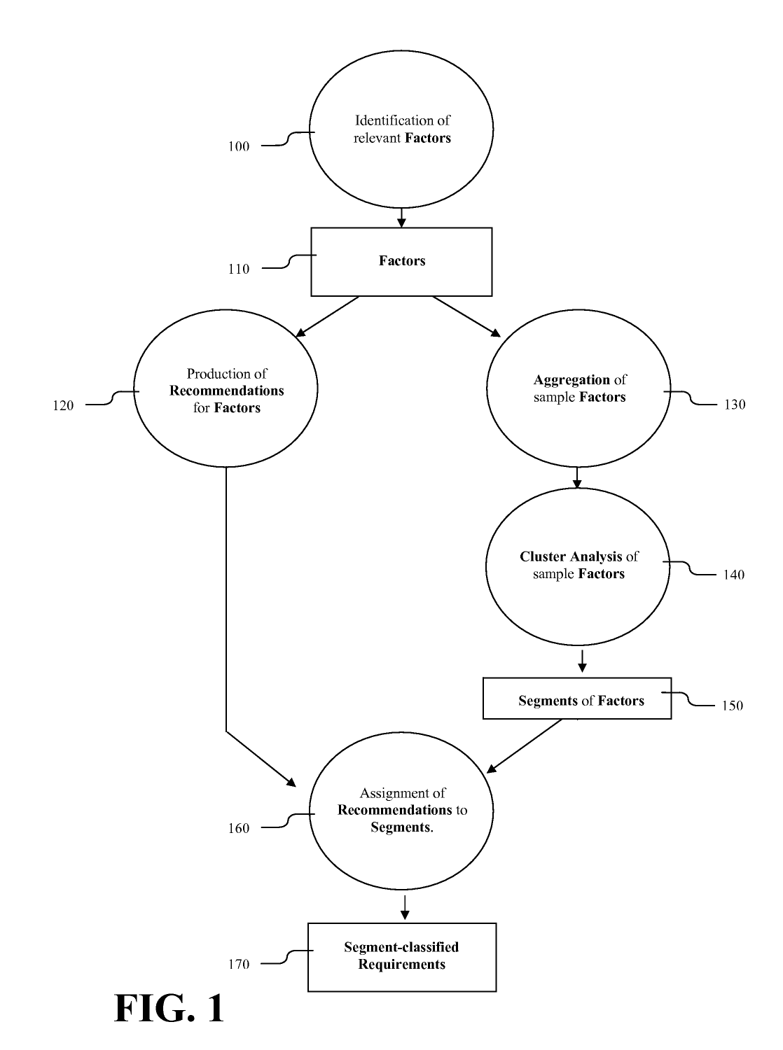

FIGS. 1-4 depict a tailored educational approach of an embodiment of the present invention method and related system. In reference to FIG. 1, factors may first be determined 100, whereby the relevant population may be differentiated. The relevant population may be a subset of the general population, such as, but not limited thereto, all potential consumers of healthcare information, potential students of a university, or potential purchasers of products. The derivation of relevant factors may begin with a general listing of potential factors. Selection of each relevant factor from this general list may be based on the strength and type of evidence regarding its influence on topical or content knowledge (e.g., health), its correlation with information-seeking behavior or status, and its influence on or correlation with behavior. Other considerations may include the degree to which the factor can be measured, its stability over time, academic interest, and its usefulness in describing segments.

Such considerations may be gleaned from an extensive literature review of existing educational materials. For example, the general listing of potential factors may be divided amongst members of a literature group. Members may then search the academic literature, and summarize their findings in a standardized format. These summaries may be combined to provide a succinct summary of the literature, from which the relevant factors 110 may be identified. Examples of relevant factors relating to individual characteristics may be learning style, age, or cultural background. Examples of relevant factors relating to individual preferences may include a subject's desired role in decision-making, preferred communication channels, or desired comprehensiveness of communications.

### Aggregation of Factors

After relevant factors 110 have been determined 100, a target sample (e.g., representative or convenient sample) of the values of those factors in the relevant population must be obtained 130. This aggregation (e.g., collection or acquisition) of individual factor values may be obtained by a survey which consists of questions designed to elicit each subject's personal set of factor values. This survey may be conducted by paper questionnaire, telephone, Internet, or other suitable means.

Alternatively, this aggregation may be mined from data which has already been obtained, perhaps, for other purposes. For example, an aggregation of the factor values of a population consisting of patients may be extracted from a representative sample of existing medical records. A person having ordinary skill in the art will recognize that there are numerous means and procedures for obtaining a representative sample of a target population's factor values.

### Cluster Analysis

After an aggregation of factor values has been obtained from the relevant population, cluster analysis is used to identify discrete segments of mean factor values based on that aggregation 140. This cluster analysis may be computer-assisted, and may consist of one or more clustering and refinement methods. Due to the size of a dataset which is representative of most populations, use of a computer processor will often be necessary. Various software packages are available which utilize one or more clustering algorithms to produce cluster solutions from user-defined and user-input data points. SPSS Inc. sells one such software package called “SPSS Base” on its website at http://www.spss.com.

A person having ordinary skill in the art will appreciate that there are numerous methods of cluster analysis available, any one of which will have its advantages and disadvantages. For instance, the k-means clustering algorithm in one form comprises the steps of: (1) specifying k number of clusters to be obtained; (2) randomly generating k number of random points as cluster centers; (3) assigning each point to the nearest cluster center; (4) determining the new cluster centers; and (5) repeating steps 3 and 4 until all points are assigned or other criterion are met. K-means clustering is simple and fast, and therefore, well-suited for clustering large sets of data. However, since k-means clustering depends initially on the random selection of cluster centers, it does not return the same result each time for the same dataset.

Alternatively, the QT clustering algorithm comprises the steps of: (1) selecting a maximum diameter for clusters; (2) building a candidate cluster for each point by including all points within the maximum diameter; (3) selecting the candidate cluster with the most points as a final cluster; and (4) repeating steps 2 and 3 for all remaining points. This algorithm does not require an ex ante selection of the number of clusters and always returns the same result for the same set of data. However, QT clustering is more costly than k-means clustering, because it requires more computing power. The appropriate clustering algorithm or set of algorithms to use will depend on many considerations unique to a particular embodiment of the present invention. These considerations may include, among other things, the resources available and the size of the dataset to be clustered.

The clustering method or methods chosen should be capable of identifying segments which accentuate the similarities within each segment and the differences between segments, and which make conceptual sense in light of the determined factors. The number of clusters is not limited but should be manageable. Furthermore, the set of clusters should be actionable, theoretically defensible, robust, and capable of differentiating consumers. Multiple cluster solutions, whether derived from multiple clustering algorithms or the same clustering algorithm using different parameters, may be compared by demographic, psychographic, and life style or behavior factors, through means analysis, in order to choose the clustering algorithm or algorithm parameters which produce a cluster solution best satisfying these desirable attributes.

For each cluster obtained by the selected clustering method, a segment is described or defined. These segments 150 are defined by the mean values of particular factors. Multiple discriminant analysis may be used to aid in defining the segments by evaluating the contribution of each factor to the distinctiveness of each cluster. Factors occurring significantly in one cluster, but not others, would become part of the differentiation of the segment corresponding to that cluster. Factors occurring in all clusters may contribute to the segment differentiation. Moreover, factors absent in all clusters may contribute to the segment differentiation. In the context of healthcare information, one segment may, for example, be defined by the presence of chronic illnesses, reliance on professional sources of information, lack of computer or Internet access, and low scores on literacy, health literacy, and numeracy. While means analysis and multiple discriminant analysis are helpful in defining the segments, they are not necessary to practice the invention, since it is possible to define the segments based solely on the factors constituting the clusters.

### Educational and Delivery Recommendations

Recommendations may be produced 120 for all of the relevant factors. A recommendation may correspond to the presence or value of one or more factors. Expert or literature review may be used to establish an index based on the values of one factor or a composite index based on the values of a group of multiple factors and to develop associated recommendations. For example, the degrees of reading literacy possessed by a population can be scaled from one to ten. The recommendation that text be supplied at a reading level of sixth grade or less may be ascribed to degrees of reading literacy falling within the factor's value range of one through four. The recommendation that text be supplied at a reading level of eighth through tenth grade may be ascribed to degrees of reading literacy falling within the index's range of five through ten. Delivery recommendations may be ascribed to ranges of a composite index based on degrees of past use, expected future use, and trust of a particular delivery option. For example, in the context of healthcare, the degree of reliance on a doctor to make health decisions as opposed to other decision-influencing sources may be scaled from one to five. The recommendation that information be deliverable at the point of care may be ascribed to degrees of reliance from 2 through 5, whereas no such recommendation should be ascribed to lesser degrees of reliance.

Each segment's factors can be rated on their corresponding indexes based on its cluster mean values. The recommendations may then be assigned 160 to the segments based on where the value of each of the segment's factors rates on that index. The recommendations may also be refined to account for any unforeseen or unexpected results of the cluster analysis. Using the previous example of the reading literacy index, if a segment demonstrates a mean degree of reading literacy of three, then the sixth grade reading level recommendation would become a recommendation for that segment.

Alternatively, recommendations may be developed directly for the sets of factor values comprising each segment produced by the cluster analysis. Development of the recommendation based on the segments will be more efficient for a single embodiment of the invention. However, development of recommendations based on numerical scales of the factor values will allow reuse of those recommendations in future embodiments of the invention.

Consequently, each segment will have a set of recommendations assigned to it 170. Using the example segment in the preceding section, the resulting recommendations may consist of supporting health behaviors and compliance, stressing the authority of the information sources, avoiding electronic materials, and utilizing auditory or low-literacy materials with few numbers and minimal medical jargon. These segments, each possessing their own recommendation, serve as a common class for the classification of both information and consumers.

### Classification of Communications

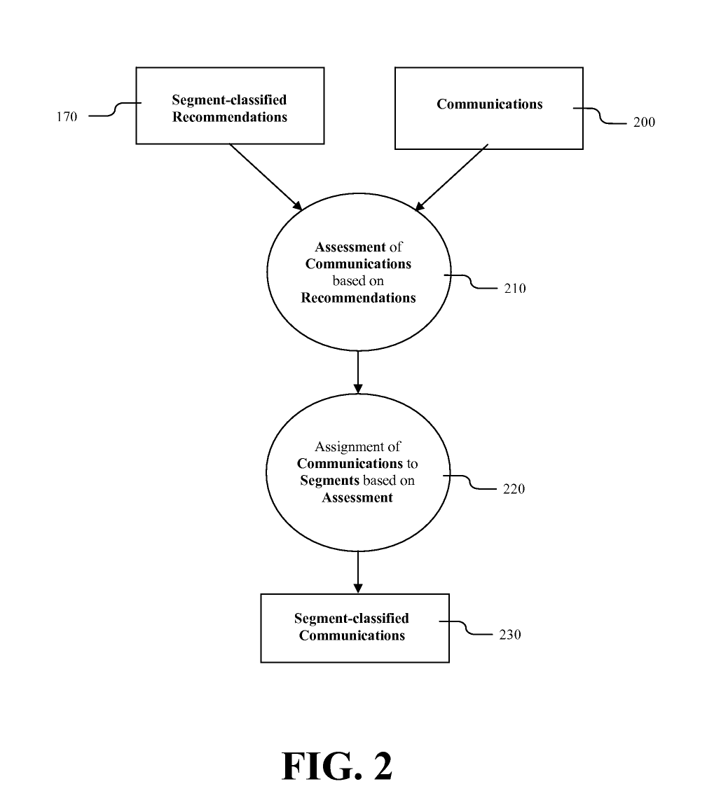

In reference to FIG. 2, communications 200 are assigned to one or more segments based on their ability to meet the segments' recommendation. Communications consist of any perceivable information or any means for communicating such information. The communications may first be categorized according to the particular recommendations which each addresses.

The communications must be rated 210. For example, a scorecard methodology may be used which asks providers or educators to choose point values corresponding to the perceived ability of each communication to address each relevant recommendation for which it has been categorized. A communication with a rating that indicates sufficient suitability to meet one or more recommendations will be assigned to the segment or segments claiming those recommendations 220. For example, educational materials that are designed at a sixth grade reading level would be suitable for those segments which claim a low-literacy recommendation. The result is a set of communications classified by the segments for which they are best suited 230.

### Classification of Consumers

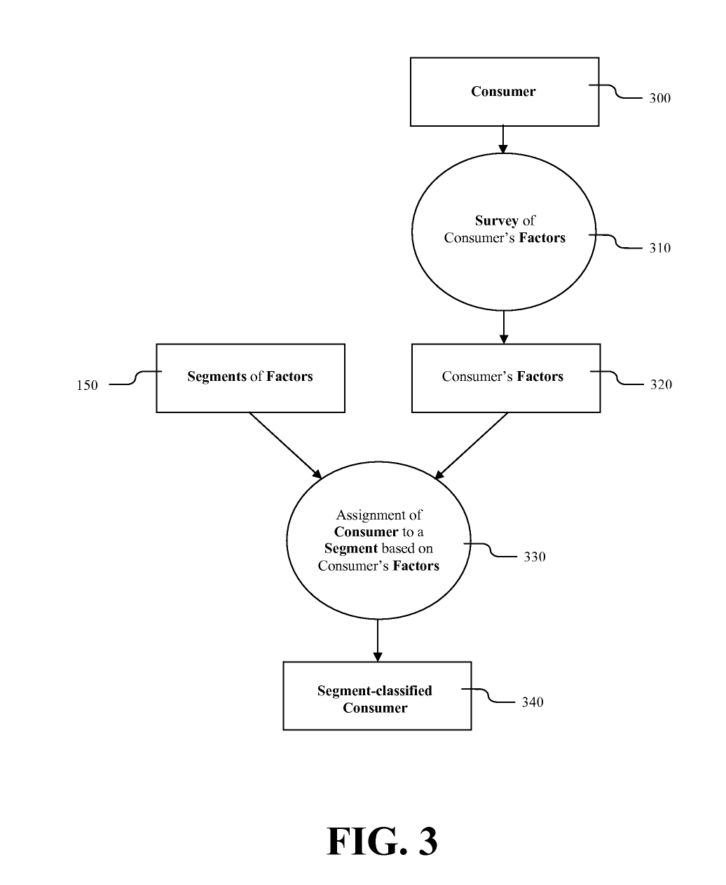

In reference to FIG. 3, each consumer 300 is classified into one of the discrete segments 150. A survey 310 is used to obtain an individual consumer's set of factor values 320. This survey should consist of questions which identify each consumer's personal factor values. The survey need not be a discrete set of questions; for example, the survey questions may be interspersed within a larger application, such as an application for the provision of healthcare. Furthermore, the survey may be conducted by paper questionnaire, telephone, Internet, or any other suitable means.

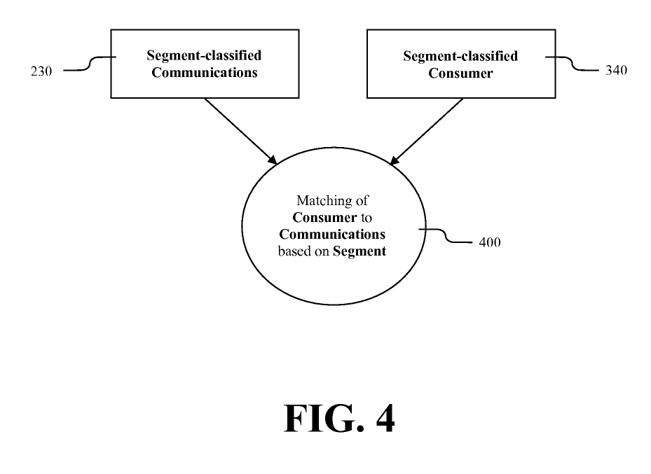

Each consumer may be assigned to the most appropriate segment 330 based on the consumer's individual set of factor values as obtained from the consumer's survey responses. This assignment may be performed using a best-fit analysis or other suitable means, including choosing the nearest segment based on Euclidean distance to the cluster mean. Once a consumer has been classified into a particular segment 340, that consumer may be provided with the communications that have also been classified into the same segment as depicted in numeral 400 of FIG. 4. This distribution of information may be continual so that as new communications become available and are classified, they may be provided to previously and identically classified consumers.

### EXAMPLE EMBODIMENT

Practice of the invention will be still more fully understood from the following examples, which are presented herein for illustration only and should not be construed as limiting the invention in any way.

An embodiment of the invention would delegate data manipulation tasks and statistical analyses to a data processing system. Decisions requiring thoughtful judgment would normally be delegated to and distributed amongst experts and information providers. To increase efficiency such judgments would be entered by the experts and providers, using any suitable input means (e.g. keyboard and mouse), directly into standardized electronic forms provided on the display screen of a data processing system. An aspect of an embodiment of the present invention contemplates that artificial intelligence may be used in many circumstances to increase efficiency where such artificial intelligence can suitably replace human judgment.

The following example embodiment will be described in the context of the provision of healthcare information. The first step is to identify those factors possessed by consumers (e.g. patients) of healthcare information that directly or indirectly influence or correlate with their informational needs. Those informational needs are composed of, among other things, any deficiencies in the consumers' health knowledge, what particular health knowledge consumers are seeking, what sources consumers are seeking their health knowledge from, the need for interventions in the consumers' health behavior.

A group of experts may be formed from various fields, including education, instructional technology, healthcare and medicine, neuropsychology, medical informatics, and program evaluation. This group may brainstorm a broad range of factors that could potentially impact a consumer's informational needs, thereby creating a list of potential factors. Partial lists of these potential factors may be divided amongst the various group members.

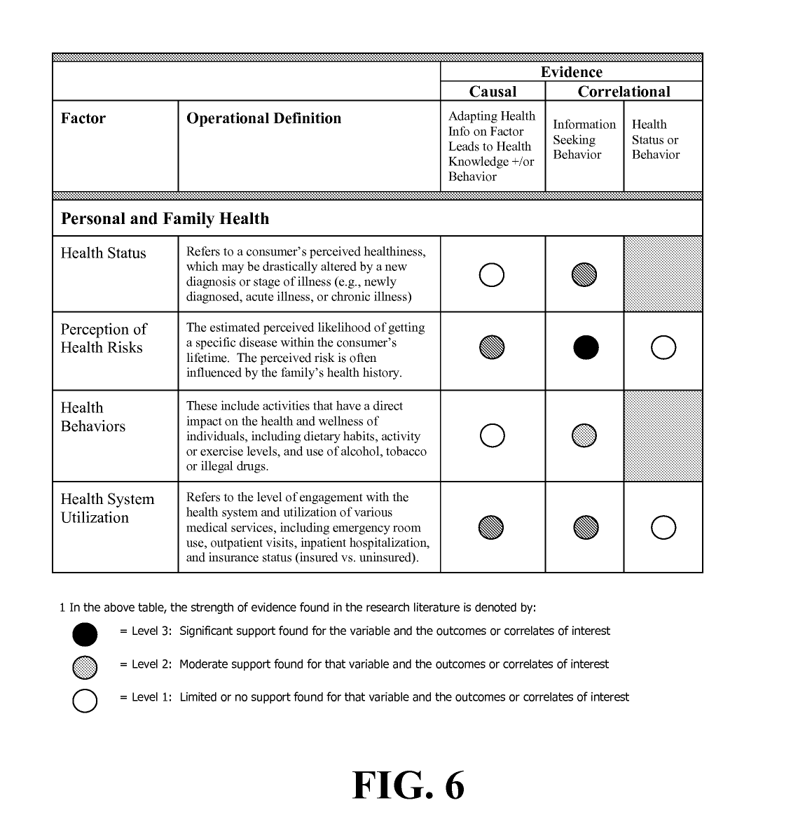

The group members may research their apportioned factors using the academic literature. Multiple search strategies may be employed, including the use of Medline, Educational Resources Information Center, Cumulative Index to Nursing & Allied Health Literature, Health and Psychosocial Instruments, PsycINFO, ISI Web of Science, and Google. The group members may then summarize their findings by entering them via remote terminals into standardized XML documents generated by a server computer. Those forms may be synthesized by a program which coordinates, aggregates, and transforms findings received from the remote terminals into a succinct summary of the literature. From that summary, the group will be able to identify the most influential factors. FIG. 6 exhibits an exemplary portion of such a summary for various factors related to personal and family health.

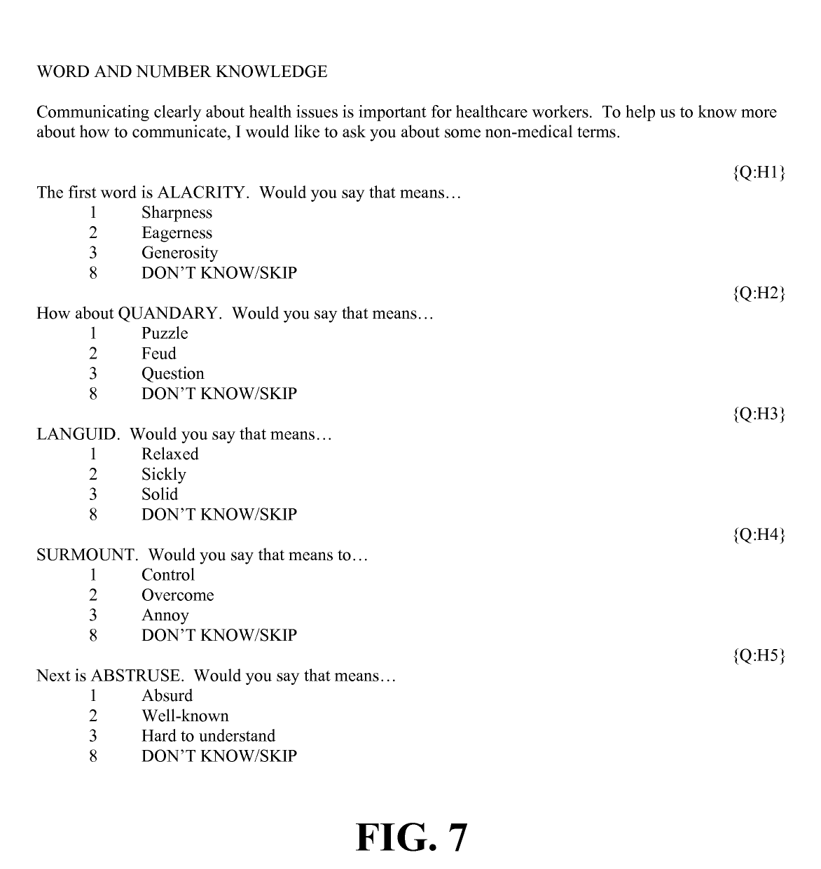

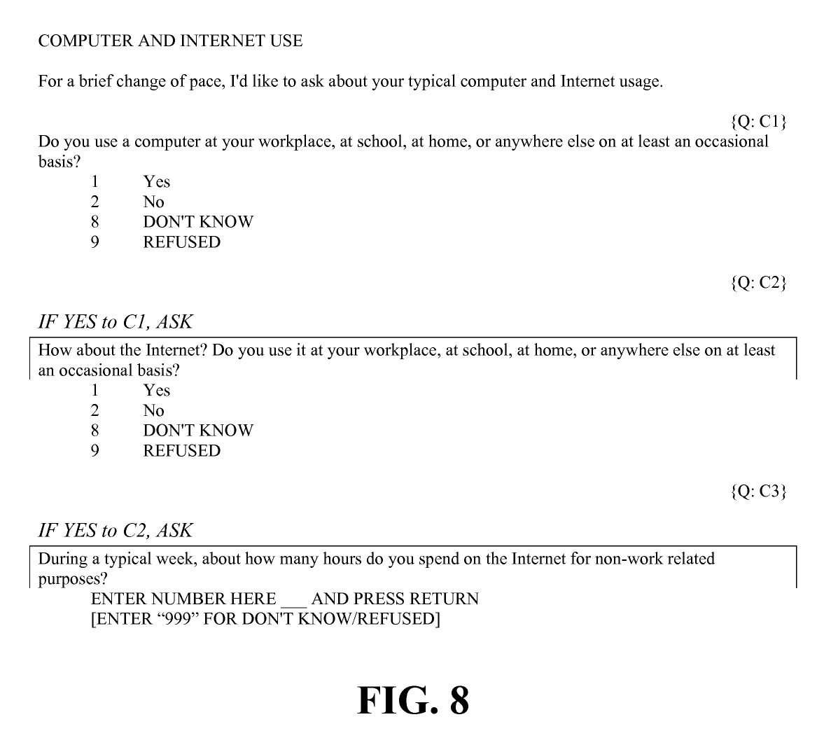

A questionnaire designed to measure the values of the identified influential factors in the population of consumers of healthcare information may be developed. A numerical scale may be developed for each factor which represents the range of the factor values in the population. The questionnaire should be composed of questions, the answers to which are capable of generating a numerical score for each factor or a composite score for multiple factors. The numerical score identifies the respondent's factor value within the factor's numerical scale. Each subject questioned may then be represented by his or her set of personal factor values. For example, FIG. 7 exhibits sample questions designed to ascertain a subject's word knowledge, which will aid in determining that subject's overall reading literacy as one of the subject's factor values. A numerical score in this example can be based on the percentage of questions answered correctly. Similarly, FIG. 8 exhibits sample questions designed to ascertain a subject's preferences regarding delivery of information.

Once the most influential factors have been identified and optimally a numerical scale has been developed for each factor, recommendations may be produced for the value of each factor or a group of multiple factors. This may be achieved through a group of experts and/or an academic literature review. The recommendations should correspond to a response to the value of a factor possessed by an individual consumer.

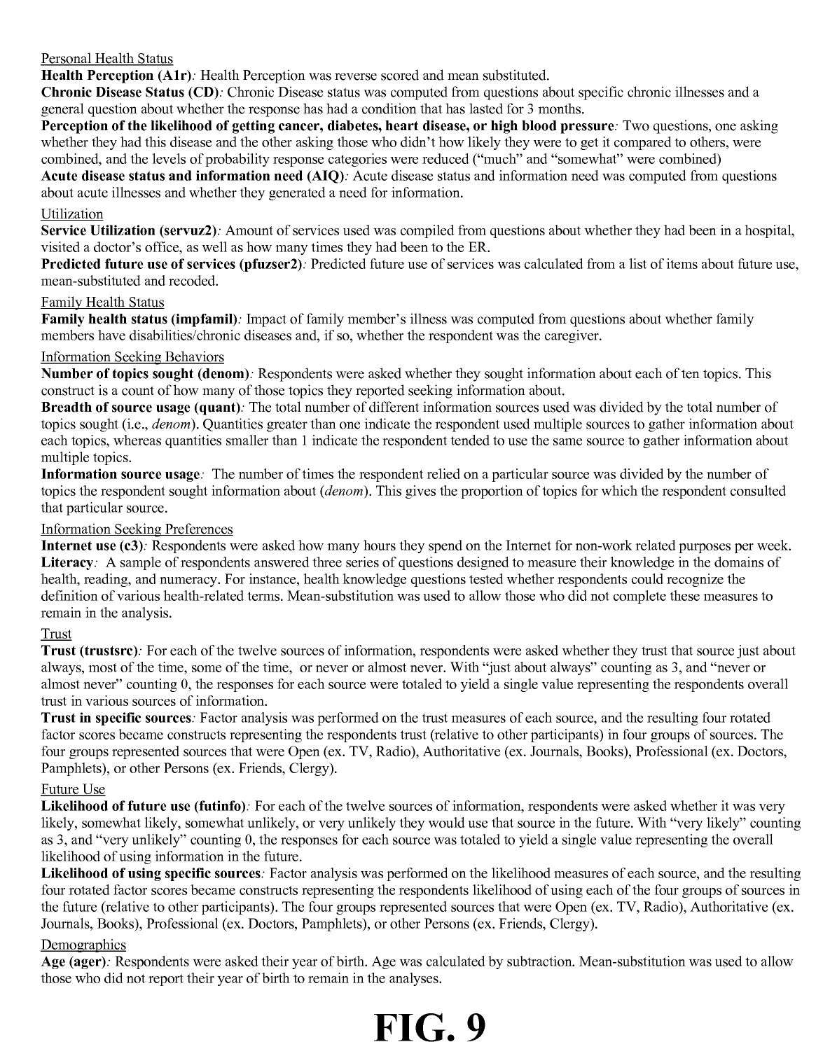

The questionnaire may be employed to obtain an aggregation of personal factor values from a representative sample of the population. For healthcare consumers, this population may be all people, since all people presumably have some need for healthcare information. Standard survey methods may be used to obtain a representative sample. For instance, a random subset of a general residential telephone listing may be obtained. That subset may be contacted by telephone and offered some appropriate incentive (e.g. cash or coupon) to participate in the survey. The telephone operator may then ask the subject the questions contained in the questionnaire and input the answers into a remote terminal using standard input devices. The answers may be transmitted via a network connection to a server computer, and translated by the server computer's CPU into numerical values for each factor or group of factors. FIG. 9 exhibits a multitude of factors and how factor values can be computed for each of them from questionnaire responses. Each subject's answers may be stored in a database, housed in the secondary memory of the server computer, as a set of numerical factor values. The result of the survey will be a dataset composed of sets of personal factor values.

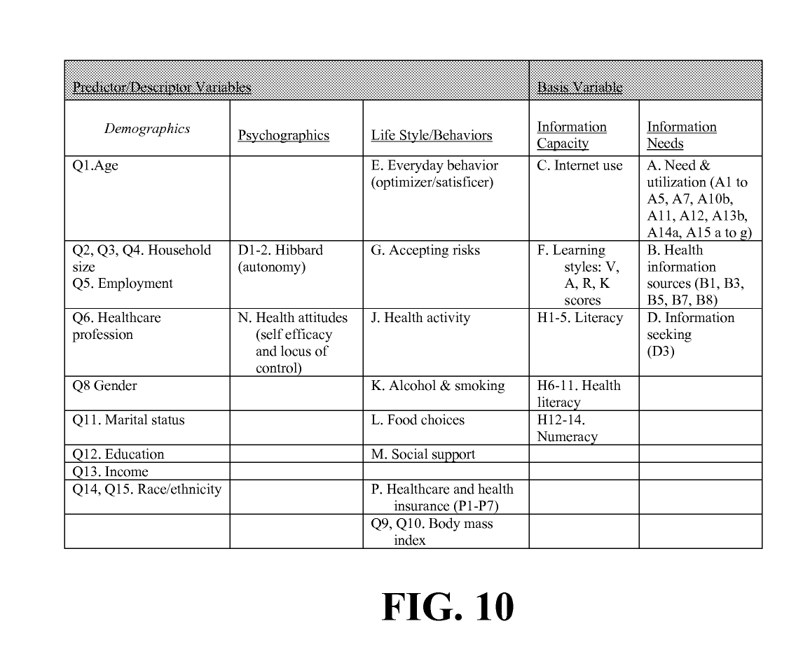

The dataset may then be operated on by a cluster algorithm, as implemented by a program in the memory of the server computer. It may be useful to segregate the factors into basis and predictor/descriptor factors, basis factors being those which most closely reflect the purpose of the study ex ante. FIG. 10 demonstrates an example of such a segregation. Cluster analysis of only the basis factors, would reduce the number of dimensions which the cluster algorithm must examine. The predictor/descriptor factors would be used to further refine and define the clusters resulting from the cluster analysis. At a minimum, the software—assuming it is implemented according to a k-means algorithm—should do the following:

(1) Read the dataset composed of sets of personal factor values (“points”) into memory.

(2) Accept a user-selected parameter k representing the number of clusters to generate.

(3) Randomly select k points and designate these as cluster centers.

(4) Assign all unselected points to the nearest cluster center, where distance is measured by Euclidean distance. For example where two points are represented by (x₁, x₂, x₃, . . . , xₙ) and (y₁, y₂, y₃, . . . , yₙ, the Euclidean distance is defined as:

\sqrt{(x₁−y₁)²+(x₂−y₂)²+(x₃−y₃)²+ . . . +(xₙ−yₙ)²}

The Euclidean distance will be calculated for every unassigned point relative to all cluster centers. The unassigned point will then be assigned to the cluster center with the minimum Euclidean distance.

(5) Compute the new cluster center for each cluster. The new cluster center will be a set of the mean values of each personal factor constituting the cluster. For example, if a cluster is composed of N points represented by (x₁, x₂, x₃, . . . , xₙ), (y₁, y₂, y₃, . . . , yₙ), . . . , (n₁, n₂, n₃, . . . , nₙ), the cluster center will be represented by point:

$$( \frac{{x}_{1} + {y}_{1} + … + {n}_{1}}{N} , \frac{{x}_{2} + {y}_{2} + … + {n}_{2}}{N} , \frac{{x}_{3} + {y}_{3} + … + {n}_{3}}{N} , … , \frac{{x}_{n} + {y}_{n} + … + {n}_{n}}{N} )$$

(6) Assign all points to the nearest cluster center.

(7) Compute the new cluster center for each cluster.

(8) Repeat steps (6) and (7) until the same cluster solution results from successive iterations.

(9) Output the cluster solution, which will be represented by k cluster centers.

The program may employ more than one cluster algorithm, or may be run using variant user-defined parameters, so that multiple cluster solutions may be compared to each other in order to find the most differentiated and actionable cluster solution. Means analysis, as implemented by a program in the memory of the server computer, may aid in the comparison of cluster solutions. The main factors of each cluster within a cluster solution can be identified by comparing the common-size mean value for each factor in the cluster against the common-size mean value for that factor in other clusters. The common-sized mean value for a factor is the mean value for that factor within the cluster divided by the overall mean value for that factor within the entire sample population. Factors with common-sized mean values which deviate far from the number one stand out as the significant factors for a cluster. The significant factors of each cluster can be compared to the significant factors of another cluster within the same cluster solution to determine whether the clusters are truly distinct.

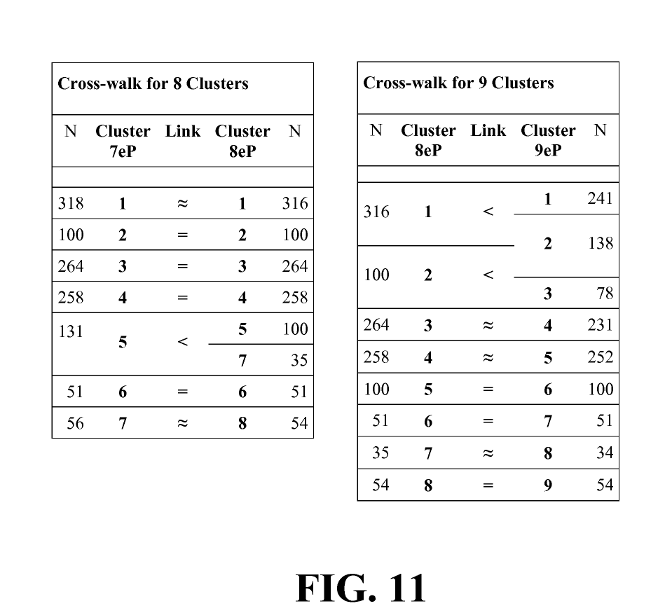

The significant factors of each cluster may also be compared to the significant factors of other clusters within a different cluster solution in order to match the cluster in one cluster solution to the most similar cluster or group of clusters of another cluster solution. In this manner, the significant factors that resulted in the differences in solutions of different cluster algorithms, or different iterations of the same cluster algorithm, will become apparent. Based on the significant factors that distinguish the different cluster solutions, the most differentiated and actionable cluster solution can be identified. FIG. 11 represents crosswalks comparing cluster solutions with seven, eight and nine clusters.

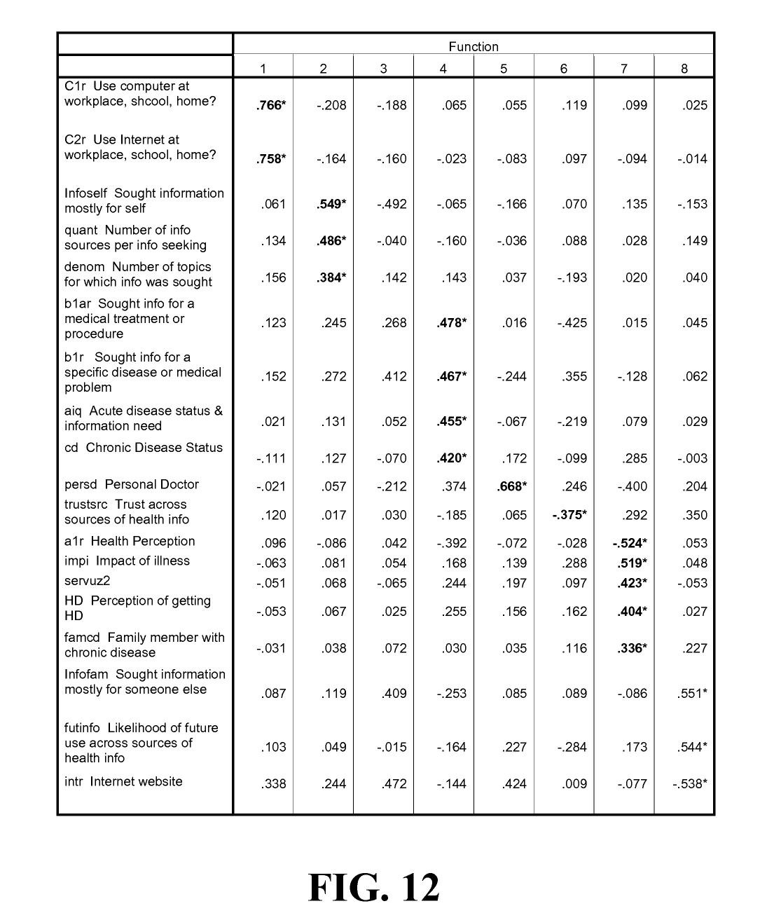

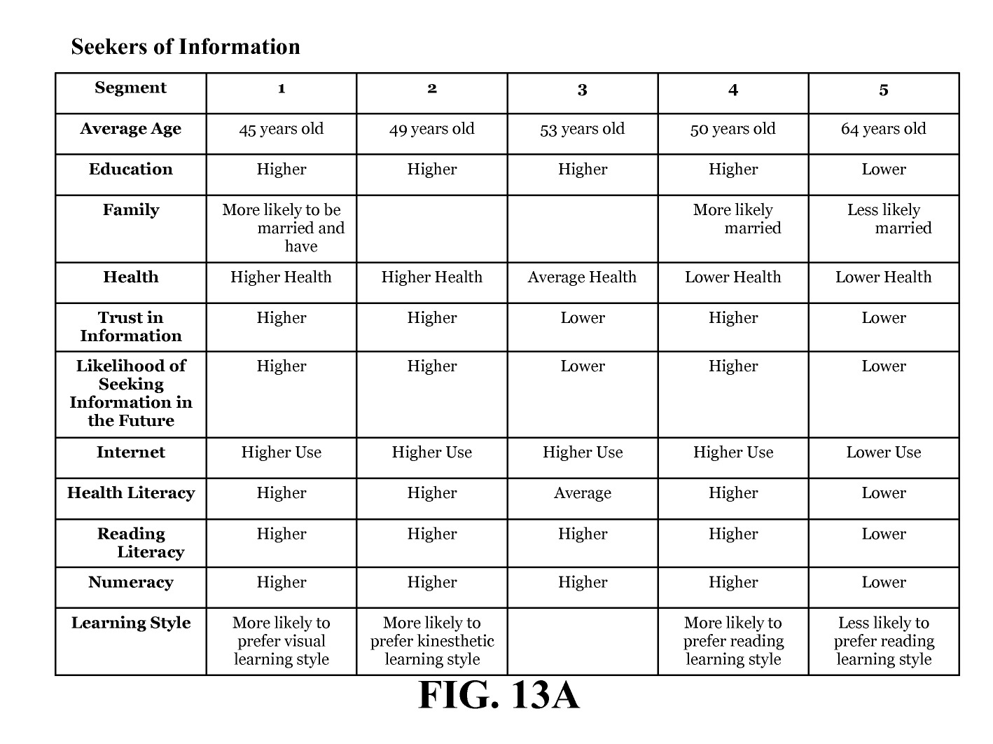

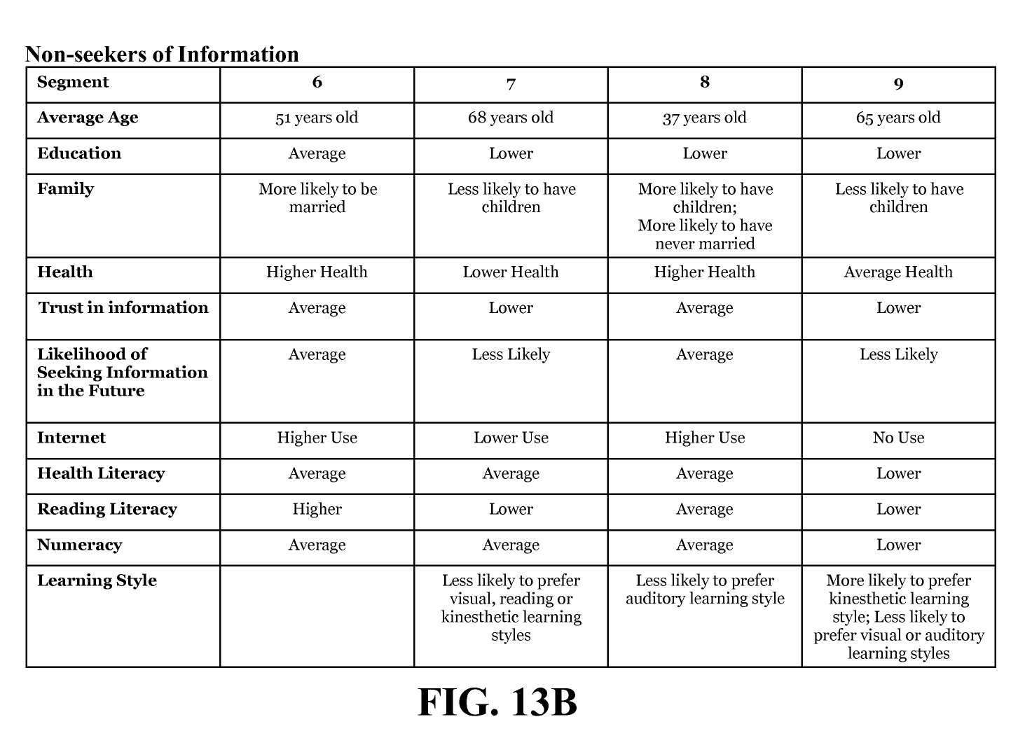

Multiple discriminant analysis, as implemented by a program in the memory of the server computer (e.g. SPSS is statistical software having such capability), may be applied to the chosen cluster solution to define population segments. Multiple discriminant analysis is well known in the art. It examines variables and identifies a number of dimensions made up of weighted combinations of variables that are most helpful in differentiating cases on a categorical variable. In this case, the variables are the factors and the categorical variable is the cluster classification. FIG. 12 exhibits an example of the functions resulting from multiple discriminant analysis of a nine-cluster cluster solution. The factors that are most helpful in differentiating the clusters may be used to define a segment corresponding to each cluster. FIG. 13A exhibits definitions of five differentiated segments which together represent those consumers who actively seek information. In contrast, FIG. 13B exhibits definitions of four additional differentiated segments which together represent those consumers who do not actively seek information.

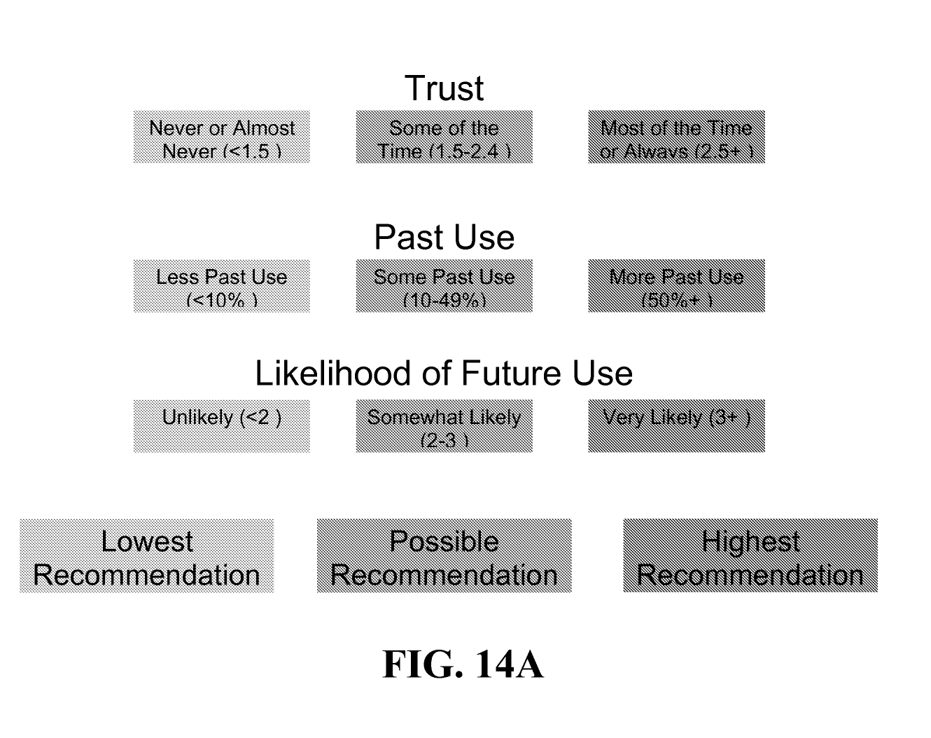

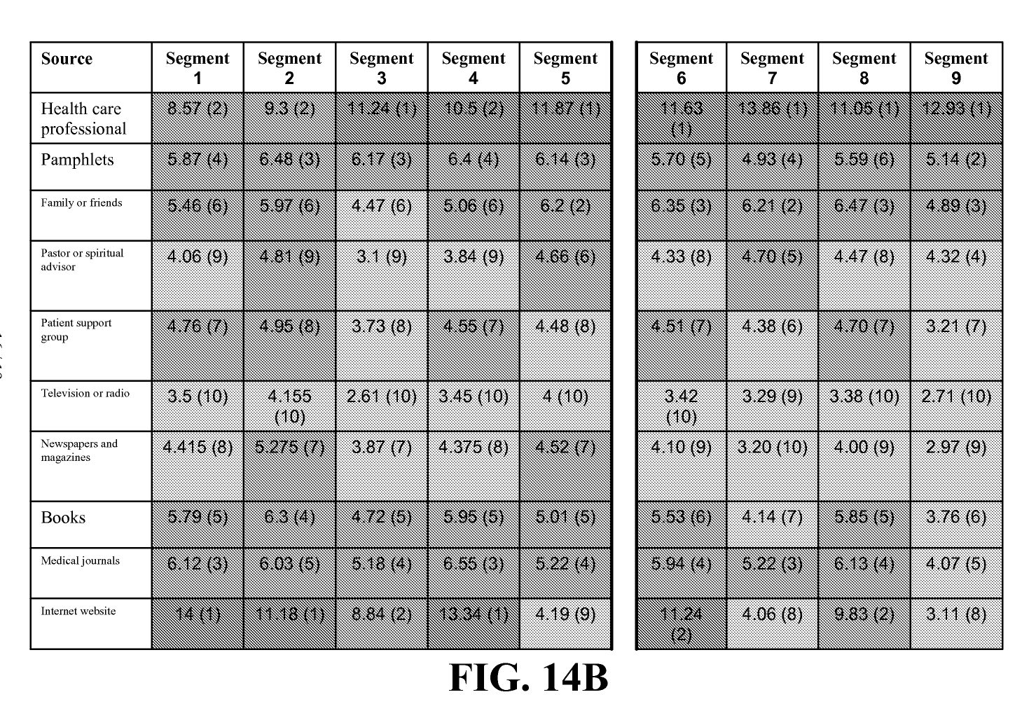

As the final step of the developmental portion of the invention, the recommendations may be assigned to the defined segments based on the mean value of each factor within the corresponding cluster. The factor mean values for each cluster are also the numerical scores within the numerical scales created for those factors. Since recommendations are specified for ranges of the numerical scales, assigning recommendations to the segments simply entails identifying which recommendations encompass a cluster's factor mean values. The recommendations should also be refined at this time to account for any unexpected results of the cluster analysis. FIG. 14A exhibits numerical scales for determining whether an unspecified delivery option should be required for a particular segment, based on the segment's mean values for the factors of trust, past use, and likelihood of future use of the delivery option. FIG. 14B exhibits the mean values for the various delivery options for each segment. Delivery recommendations s may be easily assigned by matching the mean values of FIG. 14B to the numerical scales of FIG. 14A. The result will be a set of segments, each possessing a set of recommendations which satisfy the segment's informational needs.

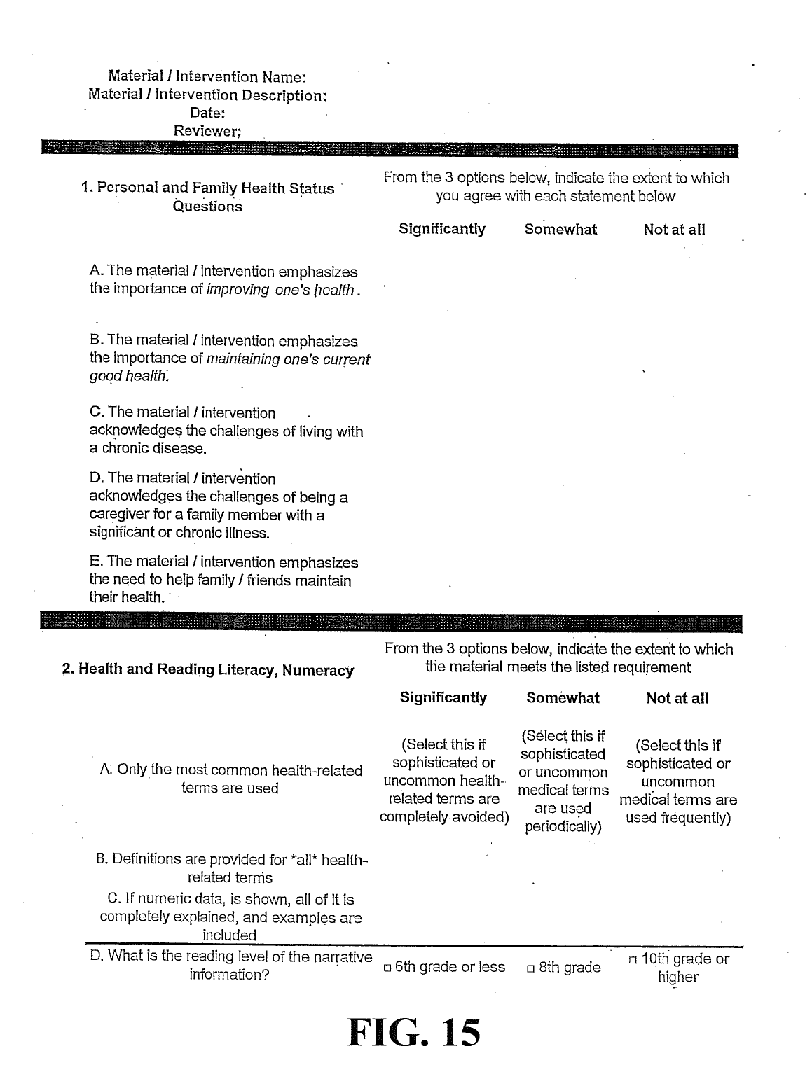

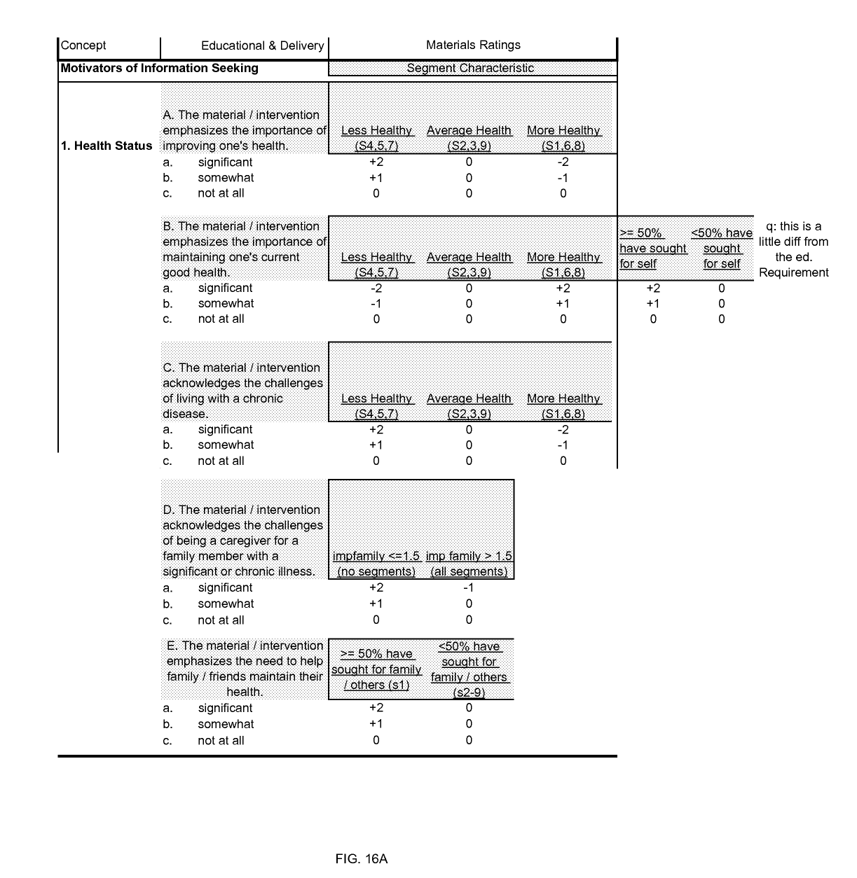

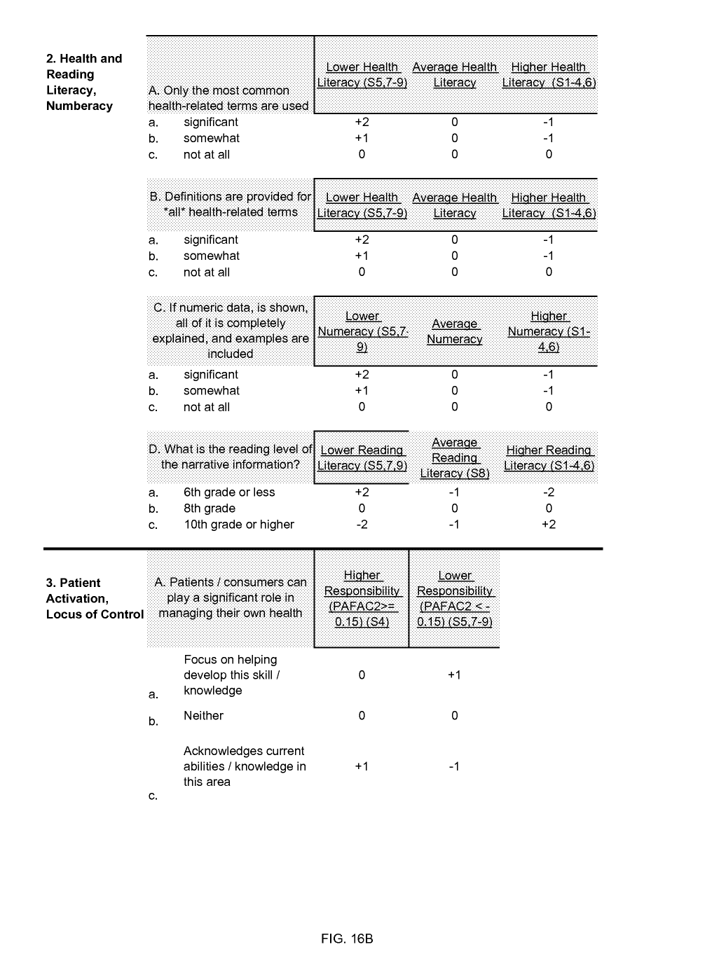

Communications may then be classified into one or more segments according to their ability to meet the recommendations of the segment. This may be implemented by human review of available communications. A questionnaire may be developed which is composed of questions that numerically rate the ability of the communication to meet each of the recommendations. The numerical scores for each recommendation may be formulated into a composite numerical score representing the material's ability to satisfy all of the recommendations of each segment. FIG. 15 exhibits some sample questions to be asked to a reviewer for the rating of a particular educational material's ability to satisfy health status and literacy recommendations. FIGS. 16A-B demonstrate how answers by the reviewer to the sample questions may be assigned point values in order to arrive at a numerical score.

The questionnaire may be electronic and distributed over a network, including the Internet, using interactive XML documents generated by a server computer, so that a number of reviewers using remote terminals may participate in the process. An educational communication's identity and numerical scores may be transmitted via the network from the remote terminal and stored in a database housed in the secondary memory of the server computer. A single educational communication may be reviewed more than once, in which case its numerical score may represent the mean of multiple transmitted numerical scores. The CPU of the server computer may read the database and formulate a communication's composite numerical score for each segment from the numerical scores for each recommendation. Those communications possessing the highest composite numerical scores for a segment may then be assigned to that segment. Segments with no high scoring materials assigned to it or with unmet recommendations should be identified as the focus in the development of future communications.

Consumers may be classified into one segment according to their personal set of factor values. A consumer's personal set of factor values may be obtained through a questionnaire. This questionnaire may be a subset of the questionnaire used to obtain a representative sample of personal sets of factor values, and may be inserted into an application for health insurance. The consumer's answers to questions corresponding to each factor may be formulated into a numerical score representing the value of the factor as possessed by the consumer. The result will be a set of numerical factor values representing the occurrence of each factor in the individual consumer. The consumer may then be assigned to the segment that corresponds to the cluster with the minimum Euclidean distance to the set of numerical factor values.

The object and result of the described embodiment is that consumers will be automatically matched to health-related communications. Communications which were assigned to the same segment as the consumer can be provided to the consumer, even if that consumer never requests information or never expresses his or her need for information. Consequently, important, and perhaps life-saving, health interventions can be achieved even before a consumer is conscious of the need.

It should be appreciated that various aspects of embodiments of the present method, system and computer program product may be implemented with the following methods, systems and computer program products disclosed in the following U.S. patent applications, U.S. patents, and PCT International Patent Applications that are hereby incorporated by reference herein:

U.S. patent application Publication Numbers

| | |
|---|---|
| 2007/0067297 | 2007/0192308 |
| 2006/0004622 | 2007/0168461 |
| 2005/0261953 | 2007/0116036 |
| 2005/0209907 | 2007/0106753 |
| 2003/0093414 | 2007/0106751 |
| 2005/0165285 | 2007/0106537 |
| 2005/0154616 | 2007/0061487 |
| 2004/0249778 | 2007/0061393 |
| 2003/0163299 | 2007/0061266 |
| 2003/0135095 | 2006/0173985 |
| 2001/0029322 | 2005/0246314 |
| 2007/0021988 | 2004/0059705 |
| 2002/0173992 | 2003/0061072 |
| 2002/0173989 | 2003/0009367 |
| 2002/0173988 | 2004/0215491 |
| 2002/0173987 | 2005/0114382 |
| 2002/0165738 | 2005/0049826 |
| 2007/0033084 | 2007/0233571 |
| 2005/0209907 | 2007/0061301 |
| 2003/0149554 | 2007/0060109 |
| 2003/0088463 | 2005/0091077 |
| 2002/0124002 | 2005/0075908 |
| 2002/0123928 | 2005/0055275 |
| 2007/0016439 | 2002/0073005 |
| 2005/0086088 | |

U.S. Pat. Nos.

| | |
|---|---|
| 3,253,129 | 5,835,897 |
| 4,506,913 | 5,819,263 |
| 4,905,080 | 7,269,568 |
| 5,245,533 | 6,842,737 |
| 5,315,093 | 7,143,066 |
| 5,331,544 | 7,110,983 |
| 5,717,865 | 7,092,914 |
| 5,933,136 | 6,938,021 |
| 6,092,069 | 6,112,181 |
| 6,347,329 | 5,207,580 |
| 6,381,744 | 7,272,575 |
| 6,484,144 | 7,085,755 |
| 6,484,158 | 6,463,585 |
| 6,704,740 | 6,286,005 |
| 6,778,807 | 6,029,195 |
| 6,865,578 | 5,956,693 |
| 6,425,525 | 6,113,540 |
| 6,849,045 | 6,022,315 |
| 6,370,511 | 5,910,107 |
| 6,206,829 | 5,868,669 |
| 5,124,911 | 5,724,968 |
| 5,041,972 | 5,660,176 |
| 6,840,442 | 5,594,638 |
| 6,952,679 | 6,745,184 |
| 6,957,218 | 6,629,097 |
| 7,069,227 | 6,549,890 |
| 7,092,964 | 6,482,012 |
| 7,177,851 | 6,193,518 |
| 7,062,510 | 6,460,036 |
| 6,996,560 | 6,029,195 |
| 6,928,434 | 6,230,143 |
| 6,895,405 | 5,446,919 |
| 5,155,591 | |

### PCT International Publications Numbers

| | |
|---|---|
| WO 2007/117980 | WO 2006/068691 |
| WO 2007/117979 | WO 2005/001631 |
| WO 2007/035412 | WO 2004/049222 |

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A method for optimizing the selection and delivery of communications comprising the activities of:
identifying a plurality of clusters of factor values possessed by a population;
producing recommendations for factor values;
assigning one or more said recommendations to each of the said clusters based on the factor values of said clusters;
assessing the ability of one or more communications to satisfy said recommendations;
assigning said communications to one or more of said plurality of clusters based on the assessments of said communications to meet the recommendations which were assigned to each cluster;
surveying a consumer with a set of questions which elicit personal factor values of said consumer to obtain said consumer's set of personal factor values;
assigning said consumer to one of said plurality of clusters based on said consumer's set of personal factor values; and
matching said consumer with the communications which are assigned to the same cluster as said consumer.

2. The method of claim 1, wherein said method is a computerized method.

3. The method of claim 1, wherein said method is at least partially a computer-assisted method.

4. The method of claim 1, wherein the factor values are numerical.

5. The method of claim 4, wherein the numerical factor values are scaled to finite ranges of numerical values.

6. The method of claim 1, wherein the identification of a plurality of clusters of factor values comprises the activities of:
identifying factors relevant to the knowledge and behavior of a population;
aggregating a plurality of sets of personal factor values belonging to a representative sample of said population; and
identifying a plurality of clusters of the said sets of personal factor values from said aggregation.

7. The method of claim 6, wherein the aggregation of a plurality of sets of personal factor values comprises the activities of:
producing a set of questions which elicit a set of personal factor values from a person within a representative sample of said population; and
surveying a plurality of persons within a representative sample of said population with said set of questions to obtain a plurality of sets of personal factor values.

8. The method of claim 6, wherein the aggregation of a plurality of sets of personal factor values comprises the activity of obtaining a plurality of sets of personal factor values from data concerning a representative sample of said population.

9. A system for optimizing the selection and delivery of communications comprising:
a device configured to identify a plurality of clusters of factor values possessed by a population;
a decision-maker which produces recommendations for factor values;
a device configured to assign one or more said recommendations to each of said clusters based on the factor values of said clusters;
a decision-maker which assesses the ability of one or more communications to satisfy said recommendations;
a device configured to assign said communications to one or more of said plurality of clusters based on the assessments of said communications to meet the recommendations which were assigned to each cluster;
a device configured to use a set of questions which elicit a set of personal factor values for a consumer to obtain said consumer's set of personal factor values;
a device configured to assign said consumer to one of the said plurality of clusters based on said consumer's set of personal factor values; and
a device configured to match said consumer with the communications which are assigned to the same cluster as said consumer.

10. The system of claim 9, wherein said system comprises a computer processor.

11. The system of claim 9, wherein the factor values are numerical.

12. The system of claim 11, wherein the numerical factor values are scaled to finite ranges of numerical values.

13. The system of claim 9, wherein the device configured to identify a plurality of clusters of factor values comprises:
a decision-maker which identifies factors relevant to the knowledge and behavior of a population;
a device configured to aggregate a plurality of sets of personal factor values belonging to a representative sample of said population; and
a device configured to identify a plurality of clusters of the said sets of personal factor values from the said aggregation.

14. The system of claim 13, wherein the device configured to aggregate a plurality of sets of personal factor values comprises:
a decision-maker which produces a set of questions which elicit a set of personal factor values from a person within a representative sample of said population; and
a device configured to use said set of questions to obtain a plurality of sets of personal factor values from a plurality of persons within a representative sample of said population.

15. The system of claim 13, wherein the device configured to aggregate a plurality of sets of personal factor values comprises a device configured to obtain a plurality of sets of personal factor values from data concerning a representative sample of said population.
